(19) United States
(12) Patent Application Publication
(10) Pub. No.: US 2012/0098641 A1
(43) Pub. Date: Apr. 26, 2012

(54) Stake With RFID Tag For Outdoor Asset Tracking

(76) Inventor: Amy Whittle, Chicago, IL (US)

(21) Appl. No.: 13/038,872

(22) Filed: Mar. 2, 2011

Related U.S. Application Data
(60) Provisional application No. 61/405,051, filed on Oct. 20, 2010.

(51) Int. Cl. H04Q 5/22

(52) U.S. Cl. 340/10.1

(57) ABSTRACT

A stake carrying an RFID tag comprises a metal body with an indentation formed into the body wherein the RFID tag is secured within the indentation. Advantageously, the indentation is sized such that when the RFID tag is placed therein, a clearance is formed around the RFID tag. A pressure sensitive label is applied over the indentation and RFID tag to seal the RFID tag within the indentation. The RFID tag allows for electronic transfer of an ID number or code to a mobile reader device to retrieve data from an RFID compatible database.

This application claims the benefit of U.S. provisional application No. 61/405,051, filed Oct. 20, 2010.

### BACKGROUND OF THE INVENTION

The present invention relates to an RFID embedded metal staking hardware for outdoor asset tracking.

An RFID tag is essentially a very small radio device that stores digital information that can be read by an RFID scanner. Typically, a passive RFID tag does not require a battery and can be powered remotely by a remote RFID interrogator or scanner to broadcast or reflect a signal that is received by the remote RFID interrogator or scanner. The RFID tag can broadcast identifying code that identifies the particular tag. The RFID tag can broadcast additional information as well. Some RFID tags can also be read/write components wherein the remote RFID interrogator can change or add information to the RFID tag.

Some systems of RFID tracking is disclosed in U.S. Pat. No. 5,825,298 and US published patent application 2009/0201154A1.

The present inventor has recognized that it would be advantageous to provide an RFID stake for tracking assets that is rugged, has improved transmitting effectiveness, and which is more cost-effectively manufactured compared to prior devices.

### SUMMARY OF THE INVENTION

The present invention provides a stake that carries an RFID tag. The stake serves as an outdoor identification post placed into the ground at a geographical location wherein the RFID tag identifies the location or assets at that location.

The RFID tag can also allow for electronic transfer of an ID number or code to a mobile RFID reading device to retrieve data from a database. The database can be in the RFID reader or remote to the reader and accessed by the reader.

The RFID tag can be an ultrahigh frequency (UHF), EPC Global, Class I, Gen 2 or higher, RFID technology.

According to one enhancement, the stake comprises an aluminum body with an indentation machined into the body wherein the RFID tag is secured within the indentation. Advantageously, the indentation is sized such that when the RFID tag is placed therein, a clearance or moat is formed around the RFID tag.

According to one enhancement, the RFID tag is secured to the stake by use of an adhesive. Furthermore, according to another enhancement a pressure sensitive label is applied over the indentation and RFID tag to seal the RFID tag within the indentation. The label serves as a sealant and enhances the aesthetic appeal of the stake.

According to another enhancement, an epoxy resin can be added into the indentation around the RFID tag to fill in the moat. The indentation and epoxy resin serve as protection for securing the RFID tag into the stake. This epoxy resin can be used with or without the pressure sensitive adhesive label.

Aluminum is an exemplary material for the stake because of its cost effectiveness and light weight and corrosion resistance in outdoor environments. A black powder coating on the Aluminum provides corrosion resistance and visual appeal.

The embodiments of the invention provide an RFID concept for solving the identification and tracking of cultivated collections or geographical locations, particularly that are solitary and do not move. The system can use a metal identification stake with an embedded or mounted RFID chip known as ROM (RFID on metal). The RFID chip can be read by a mobile or portable interrogation device in the field.

The current form of plant identification is done with metal stakes. It is important attribute that the stakes be composed of metal as they are typically in harsh conditions outdoors. These stakes are typically composed of aluminum or cold rolled steel and are powder coated flat black for durability and discreet appearance in a public setting.

An embodiment of the present invention provides a traditional metal stake that now incorporates an RFID tag. The portable or mobile interrogation device carried by a user will interface with existing software databases used by horticultural institutions and growers for inventory management and identification control. Software is used for identifying, transmitting and organizing information related to cultivated collections and crop management and geographical locations for mapping, for improved efficiency, accuracy, identification, tracking and proper documentation.

The identifying mechanism will utilize existing RFID technology such as the XERPHY PI CO x or comparable product, attached to or embedded into plant identifying stakes. The RFID tag will be written with any plant accession number or other number that corresponds to the user's accession database. The database stores the accession information and subsequently organized information according to the user's commands.

The system of the invention will allow the user to quickly access accession information or other information stored in its databases, allowing for expedited inventory, maintenance, education and a decrease in field errors. These efficiencies created by the system allow staff of institutions, growers, surveyors and construction companies, or other users the ability to function quickly in the field, and reduce errors and cost.

The system works by the RFID tag being written with an accession number identical to the associated accession number in the user database or in the case of geographical users a number associated with a location. While in the field, the user will scan the stake in a similar way that they would have previously read the label on the stake. The mobile device with an attached reader incorporated into the device will then interface with user's RFID compatible database to retrieve the information entered into the database associated with the accession number

One important attribute of the system is the ability to operate in closed database systems specific to each institution, university, arboreturn, botanic garden or grower. User input into existing programs can be used to generate reports, track assets and develop critical information in regard to each user's needs. The system can collect information from the written accession number or other number on the RFID tag and interface the accession number within the closed database used by each institution.

A further advantage of the invention is the creation of a possible application that will use the same RFID tag information in an open data base such as PLANTCOLLECTION™, a global project to upload all accession information worldwide into one user database for education purposes to the public, organized by location. When the PLANTCOLLECTION™ database is completed, the goal of the system is to be able to access the global database open to the public, enter location be able to scan the system stake in at a using institution through use of a mobile reading device. The mobile reading device will access the accession information from the RFID tag and then draw the accession number from the open database by location identification. Thus, the public will be able to use the system while they are visiting a using institution, either by organized tour or independently.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1A is a perspective view of a plurality of identifying stakes located in a botanic garden, one stake associated with a group of plants;

FIG. 1B is a perspective view of a plurality of identifying stakes located in a botanic garden, one stake for each plant;

FIG. 2 is an enlarged perspective view of an identifying stake of the present invention;

FIG. 3A is a sectional view taken generally along line 3-3 from FIG. 2;

FIG. 3B is a sectional view of an alternate configuration taken generally along line 3-3 from FIG. 2; and

FIG. 4 is a perspective view of an alternate embodiment identifying stake of the present invention.

### DETAILED DESCRIPTION OF EXEMPLARY EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

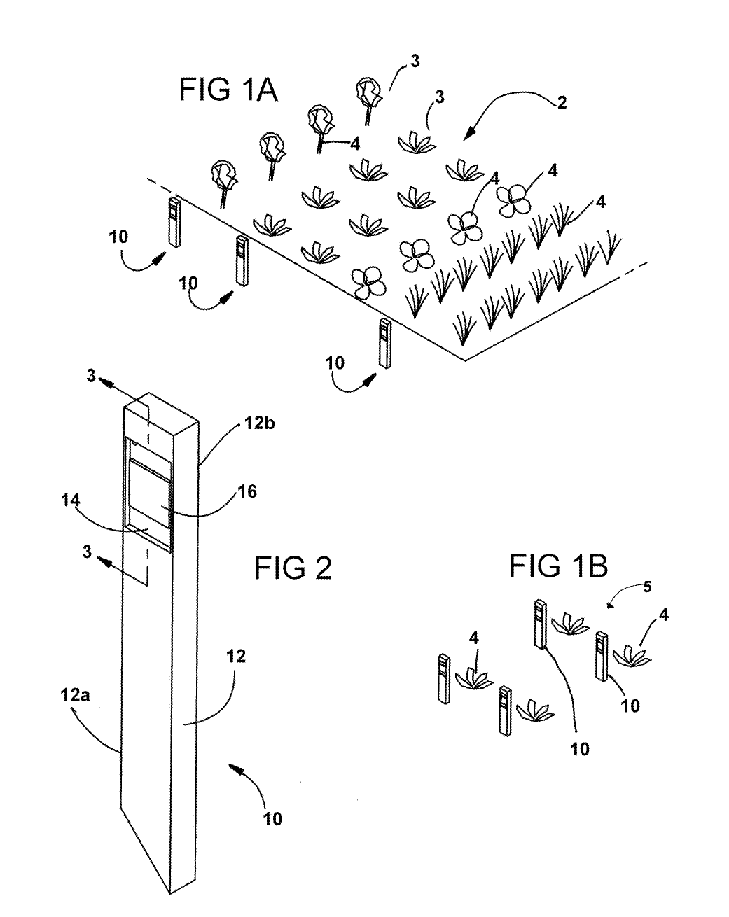

FIG. 1A discloses a planting area 2 having rows 3 of plants 4. An identifying stake 10 according to the invention is arranged adjacent selected rows 3 of the planting area 2.

FIG. 1B illustrates another planting area 5 wherein an identifying stake 10 is arranged adjacent to each plant 4. Thus, in a planting area being monitored, rows of plants or individual plants can be identified by the identifying stakes.

FIG. 2 illustrates an example of the identifying stake 10 according to the invention. The stake 10 includes a body 12 having a shank portion 12a and a post portion 12b. The shank portion 12a is advantageously formed continuously with the post portion 12b in a single strip. Advantageously the strip is an aluminum 6061 or cold rolled steel strip 0.75 in-1.5 inches wide and 0.187 in-0.250 in thick. The strip can be black power coated, using an AZKO NOBEL AN205U coating or similar coating.

Near a top of the post portion 12b, a recess or indentation 14 is formed or machined. An RFID tag 16 is secured within the recess 14. The RFID tag 16 is preferably a passive RFID component such as a NOX TM4 RFID tag with mounting adhesive, or an XERAFY MICRO-IN RFID tag.

The RFID tag 16 can be a read/write tag wherein a user with an appropriate RFID interrogator or reader can change or add information to the tag which can thereafter be retrievable by a RFID reader. The RFID tag 16 can provide a tag ID or code to be associated with an asset or accession number in a user's database.

As an enhancement, the RFID tag 16 can have the ID or code be locked or read only. The locked or read only feature prevents the system from being compromised by an unauthorized changing of tag ID's or codes.

Advantageously, the indentation or recess 14 is larger in area than the RFID tag 16 such that a clearance or moat is formed around the RFID tag 16. This indentation or recess 14 acts to enhance the reception of RFID signals and shields the RFID tag from damage due to weather or physical contact.

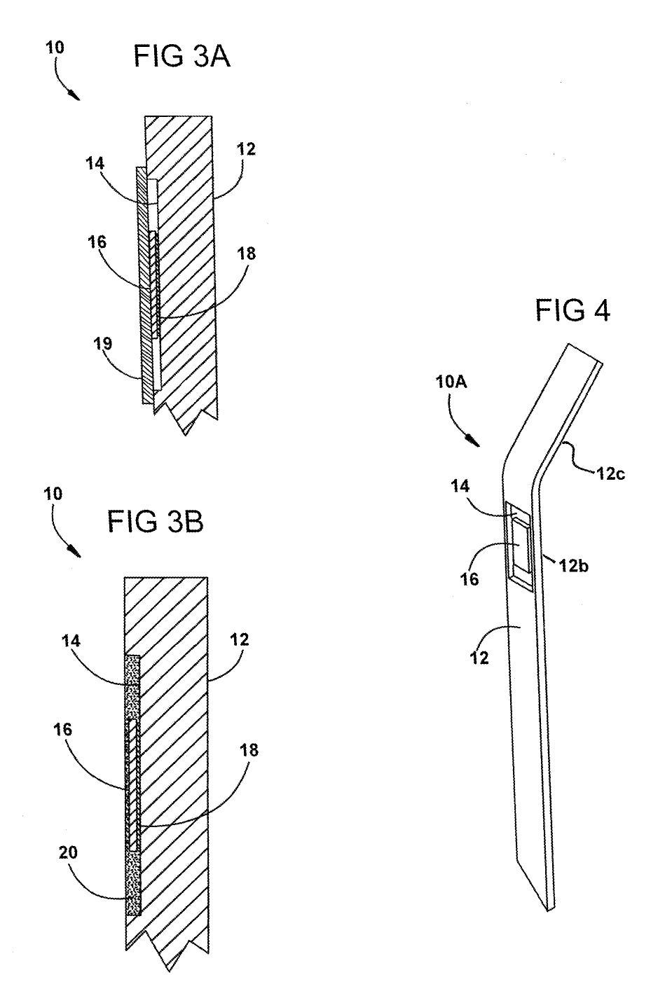

FIG. 3A illustrates in cross-section the stake 10 having the RFID tag 16 secured by adhesive 18 into the recess 14. The adhesive can be an instant adhesive such as 3M SCOTCH-WELD CA 100. A pressure sensitive adhesive label or tape 19 is applied over the recess 14 and the RFID tag 16 and encloses the RFID tag within the recess 14. One exemplary material to use for the label 19 is EXTREME TOUGH vinyl, 4 mil white gloss with 8 mil velvet polypropylene laminate overlay with adhesive.

FIG. 3B illustrates one alternate embodiment of the invention wherein a two-part epoxy resin 20, such as LOCTITE 2 PART EPDXY RESIN E-60NC is filled into the recess 14 to support and protect the RFID tag 16 within the recess 14. This embodiment could also incorporate the label 19 (not shown).

FIG. 4 illustrates an alternate embodiment stake 10a. This embodiment can be configured with the RFID tag arrangements described with respect to either FIG. 3A or 3B. This embodiment includes a post extension 12c which is angled to, or bent off from, the post portion 12b. This extension 12c allows for the attachment of an informational sign or plaque. This is particularly useful in a garden or growing area for the further identification of plants or rows of plants, particularly useful for the casual observer not having access to an RFID reader.

To manufacture one exemplary embodiment of the stake, stock aluminum strip material, such as 6061 Aluminum, is cut to length in a die with an angled tool. The stock material is machined to create the indentation 14. The stake 10 with indentation 14 is black powder coated for surface finishing. The RFID tag 16 is then attached the center of the indentation by a tool created for centering. The RFID tag 16 is attached with high viscosity adhesive, such as a SUPER GLUE. The pressure sensitive adhesive label 19 can be applied onto the stake to cover the RFID tag 16 and the indentation 14.

Alternately, the moat around the RFID tag 16 can be filled with the two-part epoxy resin 20 which has low viscosity and is not corrosive to electrical components. Optionally, the pressure sensitive label 19 can then be attached to cover the epoxy resin 20 and the RFID tag 16.

In operation, the stake is inserted into the ground at a particular asset or location that needs to be tracked or identified. The RFID tag ID or code is activated by an UHF RFID mobile reader or interrogator such as a MOTOROLA model 3090. The tag ID or code is identified in a database that carries information associated with the tag number. To ensure that the system is not compromised, the ID or code can be unique to each stake and can be locked against changes, or read only. Electronic transfer of the tag code number allows the user to easily perform otherwise time consuming manual tasks such as maintenance or inventory activities. These activities can be done faster and more accurately electronically.

The present invention is particularly advantageous for use in botanic gardens for plant identification. The need for RFID technology to be adopted and incorporated into the current plant records system and geographical mapping is important. The technology of information systems is accelerating. The importance of collecting and organizing information enhances the continuation, development and education of our society. The system concept provides a global solution for stationary asset tracking and maintenance.

The invention and can also be used for other asset tracking applications such as in construction, agriculture, mining, geographic mapping, surveying, trail mapping, utility line and pipeline tracking, underground asset tracking, military geographical tracking, safety and survey activities.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A stake for identifying characteristics at a location, comprising:
a body having a shank and a post, the shank arranged to be at least partially driven into the ground and the post extending from the shank above ground;
an RFID tag mounted to the post and containing an identifying code for the particular stake.

2. The stake according to claim 1, wherein the post comprises an indentation and said RFID tag is secured into the indentation.

3. The stake according to claim 2, wherein the indentation is larger than the RFID tag, forming a moat around the RFID tag.

4. The stake according to claim 1, wherein the post includes an offset length portion located at an end opposite the shank.

5. The stake according to claim 1, wherein the post and shank are formed as a continuous strip.

6. The stake according to claim 1, where the post and shank are composed of aluminum.

7. A system of asset monitoring, comprising:
a mobile RFID reader;
a plurality of stakes driven into the ground at selected asset locations, each stake having an above ground portion carrying an RFID tag, each RFID tag having an identifying code;
a software database having data associated with the identifying code for each RFID tag, the mobile RFID reader displaying the data associated with the RFID tag being read.

8. The system according to claim 7, wherein the stakes each have an indentation for receiving a respective RFID tag.

9. The system according to claim 7, wherein an adhesive label is applied onto each stake covering the indentation and the RFID tag within the indentation.
